(19) United States
(12) Patent Application Publication
(10) Pub. No.: US 2009/0249383 A1
(43) Pub. Date: Oct. 1, 2009

(54) BROADCAST DATA NETWORK SYSTEM

(75) Inventor: Patrick Christian, Reading, Berkshire (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Packet Vision Limited, Berkshire (GB)

(21) Appl. No.: 11/721,783

(22) PCT Filed: Dec. 14, 2005
(86) PCT No.: PCT/GB2005/004821

§ 371 Date: Apr. 11, 2008

(30) Foreign Application Priority Data
Dec. 15, 2004 (GB) 0427370.2

(51) Int. Cl. H04H 60/33; H04H 60/32; H04N 7/025

(52) U.S. Cl. 725/14; 725/9; 725/34; 725/109

(57) ABSTRACT

The invention relates to a system and method for the selective transmission of data to individuals or groups of viewing locations to thereby allow at selected times at least, the targeting of data which is more focussed or targeted to viewers at said locations. This is achieved by detecting and processing data which is indicative of the interaction of viewers with the receiving apparatus at each location and using this possibly in combination with other data, to assess characteristics of the viewers and then select the data to be transmitted to them.

The invention to which this application relates is a system for the control of the transmission and generation of broadcast data, which data can be used to generate video and/or audio and/or auxiliary information to be presented to at least one person hereinafter referred to as the viewer but more typically, a number of viewers at various geographical locations. In particular, the invention is directed towards the provision of broadcast data to viewers via satellite, cable or broadband transmission systems. The control of data to which the application is directed is particularly, although not necessarily exclusively, to allow the controlled selection of data which is broadcast to a viewer or a group of viewers at any given time and with respect to known and/or detected characteristics of said viewer or group of viewers.

The presentation of broadcast data and the method of generating the same through a transmission system is well known and will not be described in detail herein. As part of the system, it is possible to refer to known characteristics and/or to detect particular characteristics of a viewer connected to the system and, through these characteristics such as, for example, the geographical location of the viewer, it is possible to determine other likely characteristics of the viewer with a reasonable degree of certainty. The availability and subsequent analysis of this data can lead to certain broadcast data which is transmitted being targeted to pre-designated groups of viewers in accordance with the analysis of the viewer characteristics. This is particularly prevalent with respect to the provision of data in the form of adverts which are presented to the viewer at regular time intervals. For example, an advert for a broadsheet newspaper can be selectively provided to viewers in particular geographical locations by the selective generation and transmission of data representing that advert, while data for an advert for a tabloid newspaper may be transmitted to viewers at a different geographical location. However a common problem with these systems is that the viewer characteristics, and the selections made, are relatively coarse. For example, all viewers within the particular geographical location, will receive, for example, the advert for the broadsheet newspaper, whereas although all viewers are in the particular geographical location, the rest of the viewers unknown characteristics may mean that they would not be interested in the broadsheet newspaper.

It is also known to collect characteristic data of a viewer by the detection of the viewer's activities when viewing broadcast data. For example, it is known that when adverts are broadcast to viewers, many viewers change channel such that the actual presented adverts are not viewed by them and the change of channel can be detected. However, if the viewer decides they do not wish to view the target advertisement and changes to a different channel, then while this may be detected, the advertisement has still not been watched. The viewer may also find that they have been placed in an inappropriate demographic group or that the updates to the characteristics of the demographic group are slow or too coarse. Thus many individual viewers within a demographic group can be persistently presented with inappropriate broadcast data such as inappropriate adverts. This can lead to the viewer becoming frustrated and disinterested in the broadcast service and also means that monies which advertisers are spending to have the adverts broadcast, are wasted as the adverts are not directed at the appropriate viewers.

The aim of the present invention is to provide apparatus and a method which allows viewer characteristics to be more accurately defined and furthermore, allows an adaptive reaction to actions which are taken by a viewer when viewing broadcast data so as to provide an improved service to the viewer and also the provider of broadcast data.

In a first aspect of the invention, there is provided a broadcast data system for the transmission of video, audio and/or auxiliary data to a plurality of view locations, said system including apparatus of viewer's premises with which said viewer can interact to select the material being viewed or listened to and communication means whereby information representative of the interaction activity at each of said locations is transmitted to processing means for storage and generation of activity data representative of the viewing locations characteristics, wherein adaptation of operation of the apparatus at the premises and/or adaptation of the data transmitted to the at least one viewer location is selectively made with reference to the received activity data for that viewing location or group of viewing locations.

Typically the adaptation is performed with reference to awareness of the content of the video and/or audio being viewed.

In one embodiment, the adaptation is performed with respect to activity data received from a single viewer and the adaptation is applicable to only said viewer. In a further embodiment, the adaptation is made in respect to analysis of activity data received from a predetermined group of viewers and the adaptation is applicable to all viewers in said group.

In one embodiment, the activity data which is received is representative of changes made to the television channel which is being viewed by the viewer at any given time. In one embodiment, the adaptation which is made to the said processing apparatus is to delay the change of channel selection for a predetermined time or until a predetermined event has occurred. In one embodiment, the predetermined event may be the end of an advert on the first channel or indeed a group of adverts, so that the same are shown in full before the channel change is made, even if the channel change was made by the viewer during the display of the advert or a group of adverts. In this way, the broadcaster can be sure that the viewer has seen the advert or group of adverts in totality and can therefore provide more accurate information to the advertisers.

In a further embodiment, the adaptation which can be made is to recognise a viewer selection and request, select and/or store data representative of that viewer request for subsequent provision to the viewer at a time which is suitable to the viewer and broadcaster. For example, if upon viewing an advert, the viewer selects an option to receive further information relating to the advert, which would not normally be displayed, then the processing apparatus can determine whether the said additional data can be displayed in the available advertising period. If it can then the data can be displayed to the viewer straight away but if it cannot, the processing apparatus can select to store the data relating to the additional information and then display the same to the viewer at a later time.

In one embodiment, the apparatus includes a first database which includes predesignated characteristics of a viewer or a group of viewers and a second database which includes characteristics and which is reactive to actions taken by the viewer or viewers and therefore receives the activity data representative of the same. Typically the apparatus further includes a processor which controls a router and/or splicer so as to allow the selective processing and provision of the data to a viewer or viewers in response to analysis of the viewer characteristics held in the two databases.

In one embodiment the apparatus is located within a broadcast data receiver provided at the viewer location and/or provided at the viewer location in connection with the broadcast data receiver. Alternatively, the apparatus is provided at a location remote from any particular viewer location but in communication with the apparatus at the viewer or viewer's premises. Thus, for example, the apparatus can be provided at a hub from which broadcast data for a number of viewers is transmitted and the apparatus can therefore be used to control the data which is generated to that group of viewers.

In one embodiment, the apparatus as herein described can be used in conjunction with demographic control apparatus for a larger number of viewers and which apparatus can be of any conventional type. In one embodiment, the apparatus of the conventional type can feed viewer characteristics into the first database of the apparatus of the invention so that the same can be taken into account.

In a further aspect of the invention there is provided a method for the controlled provision of broadcast data to a viewer or a group of viewers, said method comprising the steps of transmitting to a viewing location or location broadcast data representative of video, audio and/or auxiliary information, wherein at least a portion of said data transmitted to a viewing location or locations is selected in accordance with known viewing characteristics at said location and/or characteristics of activity data representative of viewer's previous interaction with the apparatus at said location said data transmitted is selected with reference to said known characteristics and activity data and is transmitted to individual or a group of viewing locations.

A specific embodiment of the invention is now described with reference to the accompanying drawings, wherein:

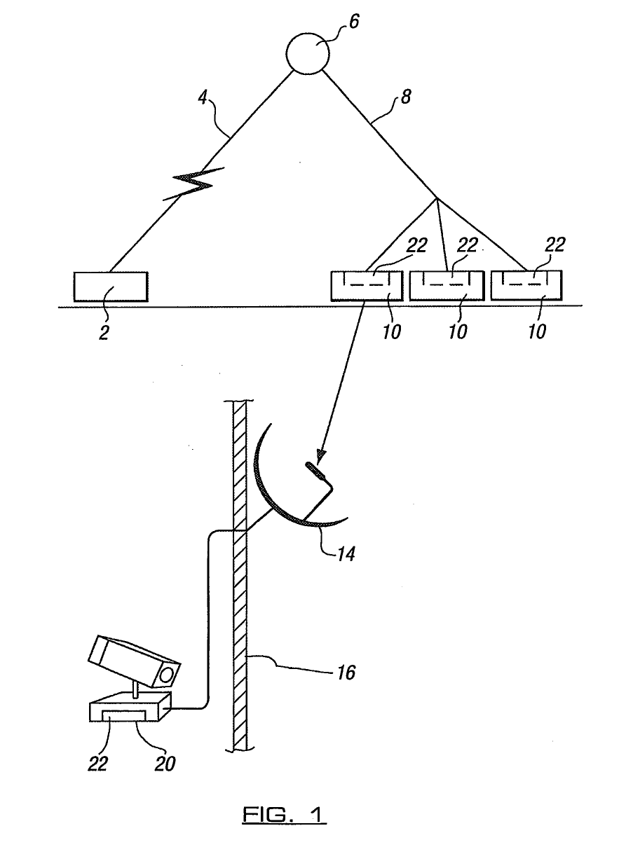

FIG. 1 illustrates in schematic manner, a broadcast data transmission system in accordance with the invention; and

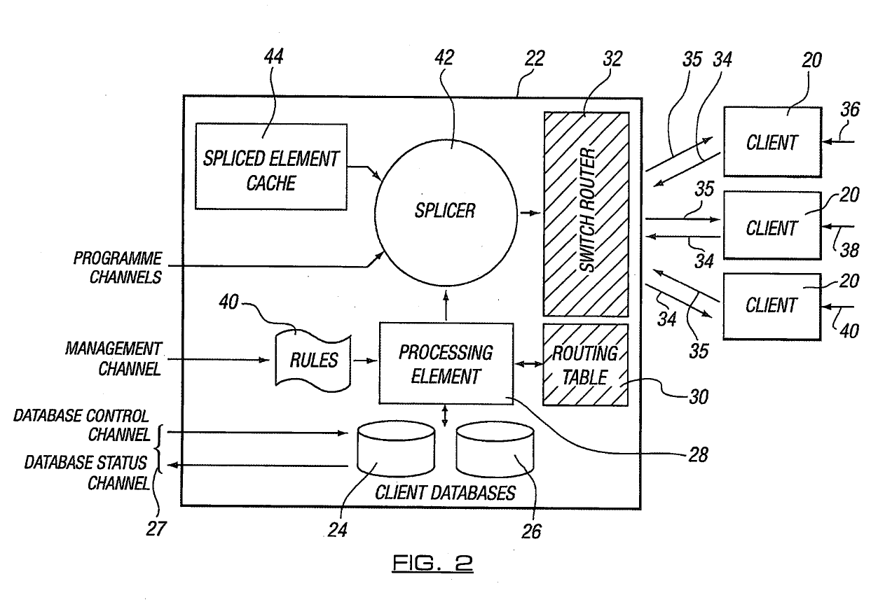

FIG. 2 illustrates apparatus in accordance with one embodiment of the invention.

Referring firstly to FIG. 1, there is illustrated a broadcast data transmission system in accordance with the invention. The invention is particularly useful with respect to an IPTV network in which the data is broadcast to the locations using internet protocol. However, other broadcast systems can be used and in the example of FIG. 1, a satellite broadcast system is illustrated and comprises a broadcast location or head end 2 from which data representative of video, audio and auxiliary information and generally representing a television network system, is transmitted 4 to a satellite 6. The satellite 6 then passes on said broadcast data 8 to a series of locations or hubs 10 from which broadcast data can be fed to a receiving antenna 14 provided at each viewer premises 16 and the data is then transferred to a broadcast data receiver 20 within the premises. In accordance with the invention, there is provided additional apparatus 22 which allows viewer activity data to be received, processed and analysed. This apparatus 22 can be provided at any suitable location such as, for example, within the broadcast data receiver 20 or, for example, at each of the hub locations 10 as illustrated in broken lines.

FIG. 2 illustrates one arrangement of the apparatus 22 in accordance with the invention. The apparatus includes a first database 24 and a second database 26, the use of which will be explained in more detail subsequently. The databases are in communication with an external control system 27 which allows known viewer characteristics to be fed into the database and also in communication with the broadcast data receivers 20 to allow information relating to the interaction between the viewer and the broadcast data receiver which occurs, and hereinafter referred to as activity data, to be sent to the databases. This activity data is received via a processing element 28, routing table 30, switch router 32 and communication channel 34 from the broadcast data receiver 20 for each viewer 36, 38 and 40 in this example. The activity data is processed and analysed with respect to the first and second databases and then the processing element 38 decides whether adaptation of the broadcast data provided to the viewer(s) is necessary. This is done with reference to preset rules 40 and any adaptation requirements are transmitted to a splicer 42 which is also fed with information from a spliced element cache 44. The splicer then feeds the adaptations to the switch router 32 and onward via communication channel 35 to the selected viewer or viewers broadcast data receiver 20, to alter the viewing of the viewer in accordance with the changes made. Thus, in operation, there is provided a context sensitive aware router/splicer (42, 32) which monitors activity data for an identified viewer or viewers such as, for example, channel change requests. The apparatus allows adaptation in the broadcast data transmitted to the receivers 20 selectively in response to, for example, the channel change request. The switch/router 32 allows the routing of streams of data to individual viewers 36, 38, 40 or groups of viewers in response to the database analysis. The splice element cache 44 allows the insertion of targeted media data such as adverts into the incoming standard transmitted live data streams in response to the adaptations which are required from the processing element 28. The first database 24 typically includes pseudo-static viewer demographic mapping data and acts as a first pass for broadcast data media targeting. The second database 26 acts as a dynamic viewer database receiving viewer activity data from the communication channels 34 and therefore is operative as a viewer context aware database and acts as a second pass adaptation of routing and spliced media selection and is also responsive to the activity data. The processing element 28, in conjunction with the rules information 40 controls the operation of the router 32 and the splicer 42.

The following information provides specific examples of operation of the apparatus and the use of the method in accordance with the invention. From the examples now given, it will be clear to the reader how the operation of the invention has significant advantages. It should however be appreciated that the following examples are non-limiting and are not the extent of the invention and that other examples of utilisation of the invention are within the scope of this invention.

In one example, a viewer request input during an advert break to change channel to another channel which is also in the process of delivering adverts could result in the current advert on the original channel continuing to be played. This is in contrast to a conventional router which would simply obey the channel change request. With this invention, the context aware router/splicer 42, 32 can maintain the targeted advert and postpone the channel change until after the advertising period. Persistent avoidance of a particular advert can result in that advert being marked as undesirable from the pool of adverts targeted at the viewer thereby allowing an alternative to be presented.

The viewer's activity data in the form of their responsiveness to the targeted adverts can be extracted and provided to other systems which are collating and updating demographic information about the individual or their group. This locally adapted information can be presented to auditing systems to indicate the actual advertising that was delivered to the individual or demographic group. The context aware router 32/splicer 42 monitors requests from each viewer. It also refers to the pseudo-static database 24 of “viewer to demographic” mappings (for selecting targeted insertions) and the dynamic viewer status database 26. The database 26 maintains live information about the viewer's activity data such as interactive requests i.e channel change, channel change rate, channel change preferences, active requests for further information). The rules processing engine 40 uses the dynamic database information to locally customise the pseudo-static demographic mappings—in order to achieve a finer granularity of viewer satisfaction and advertiser benefit.

The dynamic database information can further be retrieved and used to adapt the pseudo-static demographic mappings, e.g persistent avoidance of particular advertising may suggest that a particular client is in the wrong demographic grouping and/or their profile is wrong.

This dynamic information may also be used to audit the success of a particular targeted advert. For example, a viewer channel-change request during the advert, may not be a particularly encouragingly indication of the viewer's interest in the advert, but it is a clear indication that the advert is being watched. The context aware router 32 has the ability to decide to continue to present the advert hence ensuring it is viewed. The rules engine 40 and processing element 28 allows this local adaptation to be intelligent enough so as not to overly frustrate the viewers, e.g a rule can be included that comes into effect when three channel change requests during a particular advert against a particular viewer have been detected from the activity data and this results in the setting of a viewer specific adaptation in the dynamic database to discontinue splicing that advert for the viewer even though it is being called for in that viewer's original demographic profile. A positive/active client capability is also possible. For example, when the activity data received is for “a click for further information”, rather than a channel change the same is intercepted by the context aware router/splicer. This can then result in the apparatus ensuring that the specific viewer(s) are shown a follow-on long-form targeted advert under the local control of the context aware router. The router 32, maintaining the dynamic viewer database 26, can then splice back to the general advertising stream for that viewers demographic when the long-form advert has completed. Again this is controlled by the rules processing engine 40. For example, a rule can be devised that if a click-through event occurs when there is insufficient time to splice the long-form advert into the remaining advertising period, a flag is posted in the dynamic client database 26, to have this long-form advert inserted at the next available advertising break, overruling the targeted advertising for that viewers demographic. The rules system 40 may also locally parse and process the dynamic database to spot “democratic” or “opportunistic” trends e.g a targeted advert for a local event (a show, fair, fete etc. . . . tomorrow) achieves a positive response from those targeted (e.g click through for more information, or acquiescence, little churn-away from the advert from a particular demographic). This information can quickly be used to locally (within the context aware router/splicer) raise the priority of that advert in targeting other people who are likely to find it of interest. The ability to perform this adaptation locally and quickly ensures that, in this case, the time-sensitive “event” is delivered with maximum effect.

In a further embodiment of the invention the apparatus includes a multicast router, typically an internet protocol multicast router which is adapted for the purposes of the invention. In this example, a viewer is watching video and/or audio generated from a specific multicast stream and chooses to change the television channel which is being watched. Upon the input of a user selection typically via a remote control device a message is passed from the viewer's location to the router to indicate the new stream to which the viewer wishes to switch. In a conventional system the router would obey the request immediately. However in the case when an advert is being played this would result in the advert being missed by the viewer. In accordance with the present invention when a demand in made, an assessment would be made using knowledge of the state of the programme data stream, the demographic to which the viewer belonged and furthermore the history of viewer usage characteristics to determine either when the switch to the new channel would take place (for example after the advert had completed) or whether to allow the switch to take place and present the programme content for the existing channel for a period of time (for example the remainder of the advert) in the new multicast stream. This latter case has the further advantage that the viewer sees a channel change take place (for example the channel numbering changes) although the same spliced programme material continues to be shown. After the spliced period has elapsed the programme shown would be representative of the content of the new multicast channel.

There is therefore provided apparatus and a method which provides for the improved selection and intelligent control of the provision of television programming in response to a viewer selection.

1. A broadcast data system for the transmission of video, audio and/or auxiliary data to a plurality of view locations, said system including apparatus of viewer's premises with which said viewer can interact to select the material being viewed or listened to and communication means whereby information representative of the interaction activity at each of said locations is transmitted to processing means for storage and generation of activity data representative of the viewing locations characteristics, wherein adaptation of operation of the apparatus at the premises and/or adaptation of the data transmitted to the at least one viewer location is selectively made with reference to the received activity data for that viewing location or group of viewing locations.

2. A system according to claim 1 wherein the adaptation is performed with reference to data indicating the content of video and/or audio being viewed.

3. A system according to claim 1 wherein the adaptation is performed with respect to activity data received from a single viewing location and the adaptation is applicable to said viewing location.

4. A system according to claim 1 wherein the adaptation is made in respect of analysis of activity data received from a predetermined group of viewing locations and the adaptation is applicable to all viewing locations in said group.

5. A system according to claim 1 wherein the activity data which is received is representative of changes made to change the television channel which is being viewed by the viewer at any given time.

6. A system according to claim 5 wherein the adaptation which is made to the said processing apparatus is to delay the change of channel selection for a predetermined time or until a predetermined event has occurred.

7. A system according to claim 6 wherein the predetermined event is the end of an advert on the first channel so that the same is shown in full before the channel change is made.

8. A system according to claim 7 wherein the broadcaster can ensure that the viewing location has had access to an advert or a group of adverts in totality prior to a channel change being made.

9. A system according to claim 1 wherein the adaptation which is made is to recognise a viewer selection and request, select and/or store data representative of that viewer request for subsequent provision to the viewing location at a time which is suitable to the viewer and/or broadcaster.

10. A system according to claim 9 wherein, upon viewing an advert, if the viewer selects an option to receive further information relating to that advert, the processing apparatus can determine whether said additional data can be displayed in the available advertising period time.

11. A system according to claim 10 wherein if the data can be displayed to the viewer in the said period of time, then the data is displayed.

12. A system according to claim 10 wherein if the data cannot be displayed to the viewer in the available period of time, then the processing apparatus selects to store the data relating to the additional information and display the same to the viewer at a later time.

13. A system according to claim 1 wherein a first database is provided which includes pre-designated characteristics of a viewing location or a group of viewing locations and a second database which includes said characteristics and received activity data representative of the same interaction between the viewer and the apparatus at their premises.

14. A system according to claim 13 wherein the apparatus further includes a processor to control a router and/or splicer so as to allow the selective processing and provision of data to a viewing location or locations in response to analysis of the characteristics held in the databases.

15. A system according to claim 13 wherein the apparatus at the viewer location is a broadcast data receiver with interaction means for selective use by the viewer.

16. A system according to claim 13 wherein the said apparatus includes at the premises or at a location remote from the premises but in communication with the apparatus, said activity data processing means.

17. A system according to claim 1 wherein the apparatus can be used in conjunction with demographic control apparatus for a larger number of viewers.

18. A system according to claim 1 wherein the adaptation which is made is with respect to the video and/or audio data which is to be transmitted to the viewing location at a predetermined time or for a predetermined time period.

19. A system according to claim 18 wherein the said video and/or audio data, when processed, represents one or more advertisements.

20. A system according to claim 19 wherein the said predetermined time period is a scheduled advertising break in a television programme.

21. Apparatus according to claim 1 wherein the data is transmitted via an internet protocol television (IPTV) network.

22. A method for the controlled provision of broadcast data to a viewer or a group of viewers, said method comprising the steps of transmitting to a viewing location or location broadcast data representative of video, audio and/or auxiliary information, wherein at least a portion of said data transmitted to a viewing location or locations is selected in accordance with known viewing characteristics at said location and/or characteristics of activity data representative of viewer's previous interaction with the apparatus at said location said data transmitted is selected with reference to said known characteristics and activity data and is transmitted to individual or a group of viewing locations.

23. A method according to claim 22 wherein the characteristics for each viewing location or group of viewing locations is updated as activity data is received.

24. A method according to claim 22 wherein the characteristics for each viewing location indicate any or any combination of, wealth, particular topics of interest, and/or age.

25. A method according to claim 22 wherein the characteristics for a particular viewing location change during a time period so as to indicate when different viewers at the location interact with the apparatus.

26. A method according to claim 25 wherein the data which is selected to be transmitted is selected with reference to the characteristics for the viewing location and the time at which the data is to be transmitted.

27. A method according to claim 22 wherein certain data is transmitted to all of the said viewing locations and certain data is selectively transmitted to said viewing locations.

28. A method according to claim 27 wherein data representative of programmes is transmitted to all locations and data representative of adverts is selectively transmitted to said locations.

29. A method according to claim 22 wherein the data is transmitted via an IPTV network.
